(19) United States
(12) Patent Application Publication
(10) Pub. No.: US 2006/0032122 A1
(43) Pub. Date: Feb. 16, 2006

(54) Mangrove seedling & plantation methodology

(76) Inventor: Min-Hsien Chang, Chia I Hsien (TW)

Correspondence Address: LEONG C LEI, PMB # 1008, 1867 YGNACIO VALLEY ROAD, WALNUT CREEK, CA, 94598, US

(21) Appl. No.: 10/892,215

(22) Filed: Jul. 16, 2004

(51) Int. Cl. A01G 9/10

(52) U.S. Cl. 47/58.1 SE; 47/77

(57) ABSTRACT

A mangrove seedling and plantation methodology to upgrade the survival rate of mangroves by having seedlings grow in smaller pots; when grown to a certain extent the saplings being transplanted to hollow tube containers made of organic substances; the containers seated into a saline fish farm before being further relocated to seashore at certain spacings separated by footpaths between fields where roots are developed for saplings to grow into mangrove forests; and those organic containers being left to decay.

### BACKGROUND OF THE INVENTION

(a) Technical Field of the Invention

The present invention is related to a mangrove seedling and plantation methodology, and more particularly, to one which upgrades the surviving rate of growing mangroves.

(b) Description of the Prior Art

Mangrove saplings are usually directly planted on the seashore. However, as the tide ebbs and rises, the fragile saplings are subject to constant pushing causing them to bend, collapse or even break up resulting in a comparatively low survival rate of mangroves. Furthermore, when limited by geological conditions, it is impossible to plant mangrove saplings among rock crevices along the seashore.

### SUMMARY OF THE INVENTION

The primary purpose of the present invention is to provide a mangrove seedling and plantation methodology to provide good protection and cultivation for the mangroves during the seedling and plantation processes thus to upgrade the survival rate of mangroves. To achieve the purpose, the mangrove saplings are first grown in pots. When saplings grow to a certain extent, they are transplanted to hollow pipe containers made of organic substances, such as bamboo, and those containers are placed in a saline fish farm. Once the roots of saplings are developed, the containers are relocated to sand land or rock crevices along the seashore to grow into mangrove forests.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing saplings of mangrove are planted in smaller pots of the present invention.

FIG. 2 is a schematic view showing how the saplings are transplanted into organic containers of the present invention.

FIG. 3 is a schematic view showing the containers placed in fish farms.

FIG. 4 is a schematic view showing the containers relocated along the seashore.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

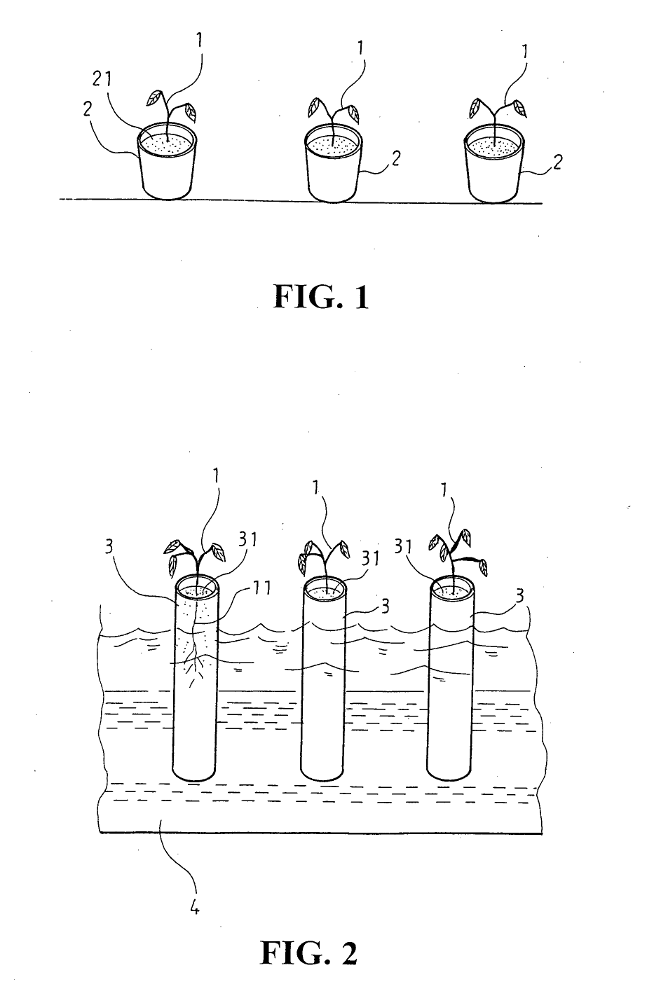

Referring to FIGS. 1 through 4, the mangroves seedling and plantation methodology of the present invention is provided in the following four steps:

Step 1: Saplings 1 are placed in smaller pots 2 containing soil 21 and multiple pots are then placed in a seedling garden as illustrated in FIG. 1.

Step 2: Allow saplings 1 grow to a certain extent, and those saplings 1 are transplanted into hollow containers 3 made of organic substance and filled with soil 31. Those containers 3 growing saplings 1 are then planted in a saline fish farm 4 on the seashore for those saplings 1 to grow roots as illustrated in FIG. 2.

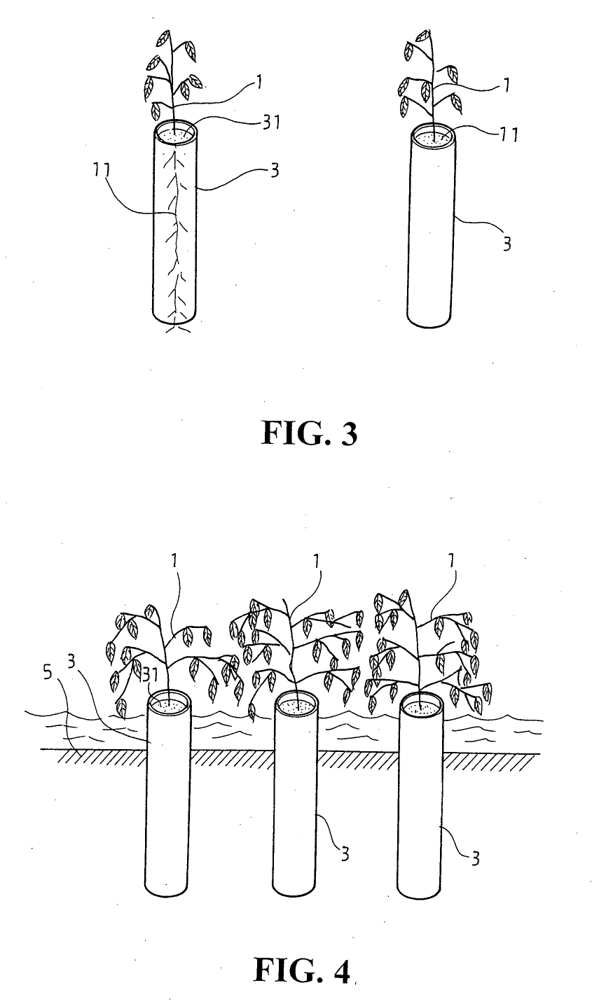

Step 3: Once the roots 11 of the saplings 1 in containers 3 are fully developed in the soil 31 inside the containers 3, containers 3 growing saplings 1 are removed from the fish farm as illustrated in FIG. 3.

Step 4: Those organic containers 3 containing saplings 1 removed from the fish farm are relocated to sandy land 5 or crevices among rocks on the seashore for their roots to continue grow into the sandy land 5 while saplings 1 continue to grow into woods of mangroves as illustrated in FIG. 4.

Whereas the container 3 is made of organic substance such as bamboo, the container 3 will be naturally decayed due to the long-time erosion by seawater without contaminating the environment.

The present invention, by protecting saplings 1 with the containers 3 during the seedling and plantation processes from seawater to practically assure a 100% survival rate, provides an effective, extremely high success rate for growing mangroves.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mangrove seedling and plantation methodology having mangrove seedlings grown first in smaller pots containing soil; when grown to a certain extent the saplings being transplanted to hollow tube containers made of organic substances; and the containers being seated into a saline fish farm before being further relocated to the seashore at a certain spacing separated by footpaths between fields when roots are being developed for saplings to grow into mangrove forests.

2. The mangroves seedling and plantation methodology of claim 1, wherein, the organic hollow container is made of bamboo or similar substances.
